(19) United States
(12) Patent Application Publication
(10) Pub. No.: US 2013/0294826 A1
(43) Pub. Date: Nov. 7, 2013

(54) LOCK-IN SLIDE RACK

(71) Applicant: Shiping CHEN, Fremont, CA (US)

(72) Inventor: Shiping CHEN, Fremont, CA (US)

(73) Assignee: ADVANCED CELL DIAGNOSTICS, INC., Hayward, CA (US)

(21) Appl. No.: 13/887,228

(22) Filed: May 3, 2013

Related U.S. Application Data
(60) Provisional application No. 61/642,591, filed on May 4, 2012.

(51) Int. Cl. F16B 2/06

(52) U.S. Cl. CPC F16B 2/06
USPC 403/373

(57) ABSTRACT

The invention provides an apparatus for securing an object on a frame, wherein the object comprises a surface for displaying a sample. The apparatus can comprise a first clamping member movably mounted on a frame, wherein the first clamping member changes from an open position to a closed position to secure an object on the frame.

This application claims the benefit of priority of U.S. Provisional application Ser. No. 61/642,591, filed May 4, 2012, the entire contents of which are incorporated herein by reference.

### BACKGROUND OF THE INVENTION

The present invention relates generally to an apparatus for securing an object on a frame, and more specifically to rack for securing slides.

Microscope slides are the most commonly used platform for carrying biological or chemical specimens for processing and examination. Most of these slides are made of glass, but some are made of plastics or other materials.

Many assays using microscope slides carrying a biological or chemical specimen for scientific research and disease diagnosis comprise a repeated sequence of incubation and washing steps. Slides have to be individually transferred back and forth between horizontal and vertical racks between these steps, a very tedious, time consuming and labor intensive task.

Thus, there exists a need to provide more efficient ways to process slides for various uses, for example, processing multiple samples on multiple microscope slides. The present invention satisfies this need and provides related advantages as well.

### SUMMARY OF INVENTION

The invention provides an apparatus for securing an object on a frame, wherein the object comprises a surface for displaying a sample. The apparatus can comprise a first clamping member movably mounted on a frame, wherein the first clamping member changes from an open position to a closed position to secure an object on the frame.

### BRIEF DESCRIPTION OF THE DRAWINGS

FIG. 1 depicts a horizontal slide rack.

FIG. 2 depicts a vertical slide rack.

FIG. 3 depicts a slide rack with a fixed cage structure.

FIG. 4 depicts an example lock-in slide rack assembly, according to one embodiment of the present invention.

FIG. 5 depicts a side, see-through view of the example rack assembly as shown in FIG. 4, where the swing clamps rotated to an open position allowing microscope slides being loaded onto the rack.

FIG. 6 depicts a top view of the example slide rack assembly as shown in FIG. 4, where the swing clamps rotate to a closed position to secure the slides on the rack.

FIG. 7 depicts a side, see-through view of the example rack assembly as shown in FIG. 4, where the swing clamps rotate to a closed position to secure the slides on the rack.

FIGS. 8(a)-8(d) depict an example locking mechanism on the example rack assembly as shown in FIG. 4, according to one embodiment of the present invention.

FIG. 9 depicts the example lock-in slide assembly as shown in FIG. 4, loaded with microscope slides inside a flat-bottom bulk reagent tray.

FIG. 10 depicts an example lock-in slide assembly with swing clamps and an additional fixed clamp, according to another embodiment of the present invention.

FIG. 11 depicts a side, see-through view of the example lock-in slide assembly as shown in FIG. 10 during a slide-loading operation.

FIG. 12 depicts a side, see-through view of the example lock-in slide assembly as shown in FIG. 10 after a swing clamp rotates to a closed position.

FIG. 13 depicts an example lock-in slide assembly with a central clamp, according to yet another embodiment of the present invention.

FIG. 14 depicts the example lock-in slide assembly as shown in FIG. 13, with the central clamp at a closed position.

FIG. 15 depicts example openings in an example lock-in slide assembly for fluid access and drainage.

### DETAILED DESCRIPTION OF THE INVENTION

The invention relates to an apparatus for securing an object such as a microscope slide on a frame. The apparatus is useful for efficient processing of slides, in particular processing slides carrying a biological or chemical specimen.

The invention described herein includes a lock-in rack, which can comprise a movable clamping mechanism. When the clamping mechanism is at its open status, multiple slides carrying specimens can be easily loaded into the rack. After slide loading, the clamping mechanism can be conveniently changed to a “closed” status, which holds slides in constrained positions. Further, a lock mechanism can be implemented on the clamping mechanism, which securely locks the clamping mechanism at its closed status, allowing the slides to be fixed at their respective positions within the rack and robustly withstand vigorous washing and shaking.

Microscope slides are the most commonly used platform for carrying biological or chemical specimen for processing and examination. Most of these slides are made of glass, but some are made of plastics or other materials. The standard slides have a rectangular shape and are approximately 3 inches by 1 inch (75 mm×25 mm). However, slides of other sizes or shapes are also used.

Microscope slides are used in various applications and are commonly used for processing samples such as biological specimens. For example, microscope slides are used for processing biological specimens, such as tissue slices, cell cultures, smears of biological fluids, and the like. For example, tissue slices, cell cultures or smears can be used in assays including, but not limited to, immunohistochemistry (IHC), immunocytochemistry (ICC), in situ hybridization (ISH) with nucleic acid probes, and the like. Such techniques are often used in a clinical setting to analyze tissue or bodily fluid samples such as tissue biopsies, bodily fluids or specimens, including but not limited to saliva, sputum, blood, serum, urine, fecal specimens, dermal scrapings from the skin or inside the mouth or nasal passage, and the like. Other applications using microscope slides include assays in an array configuration, for example, nucleic acid or oligonucleotide arrays or peptide or peptidomimetic arrays. Thus, the invention relates to an apparatus for securing an object to a frame, for example, an object comprising a surface for displaying a sample. In one embodiment, the object is a microscope slide. However, it is understood that the apparatus can be used for securing any appropriate object, in particular an object comprising a surface suitable for the display of a sample, including but not limited to a microscope slide or other similar object having a surface for displaying a sample. Such a sample can be a biological sample such as a biological specimen or biological molecules such as nucleic acids or peptides, and the like, as disclosed herein.

Embodiments of the apparatus of the invention can be conveniently used to process objects such as microscope slides for various applications, as described herein. The invention thus provides methods of using an apparatus of the invention to carry out such assays. As described herein, the apparatus of the invention is particularly useful for processing samples utilizing precious reagents, for example, reagents of limited quantity or that are expensive. As disclosed herein, an apparatus of the invention allows precious reagents to be applied in a position, i.e., horizontal, to minimize the reagent volume to be applied to the sample, while also conveniently allowing repositioning of the apparatus, for example, to a vertical position, to allow convenient and rapid processing of the slides for use of bulk reagents, such as reagents used for washing steps. An apparatus of the invention additionally provides the ability to conveniently and rapidly eliminate excess residual reagents remaining on the slides after an incubation and/or wash step. Furthermore, an apparatus of the invention is configured for ease of placement of the slides on the apparatus, which minimizes handling of the slides for attachment to the apparatus and thereby minimizes possible contamination or damage to the specimens on the slides. An apparatus of the invention can be used manually or can be used or configured to be used in an automated process such as for automated assays.

When multiple slides are processed and examined in a batch, a slide rack can be used to handle them together. Such batch processing not only occurs in manual assays but also most likely required in automated assays. There are mainly two types of slide racks currently in use, vertical and horizontal.

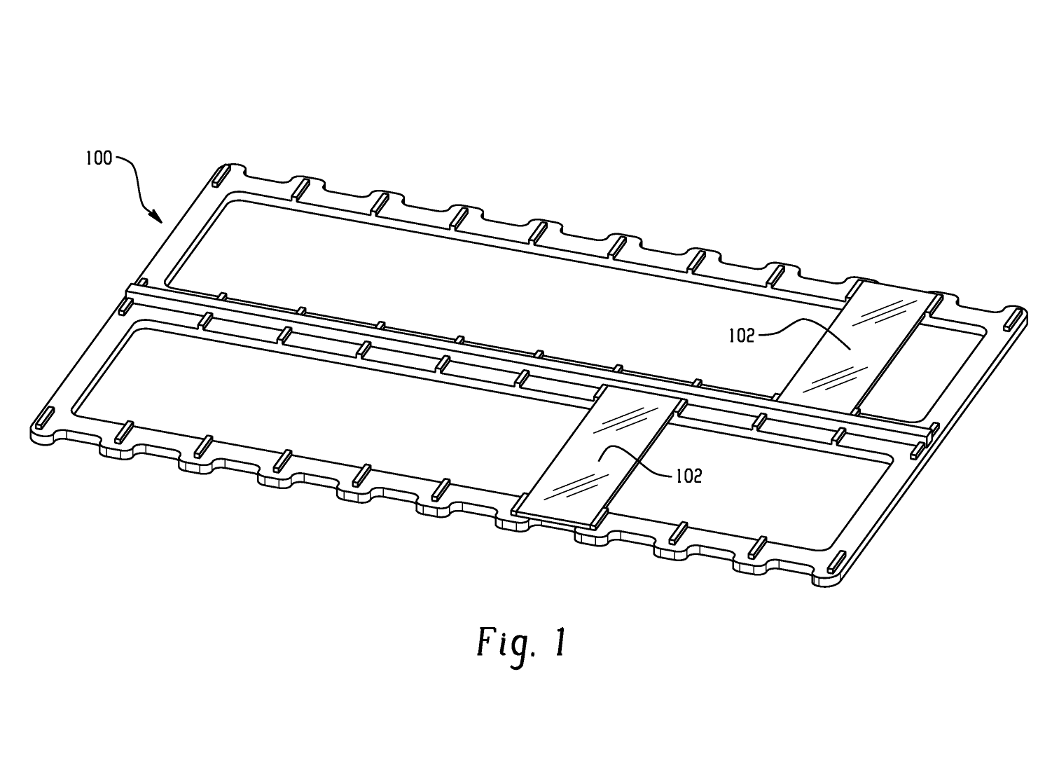

FIG. 1 depicts a horizontal slide rack 100. As shown in FIG. 1, microscope slides 102 are placed horizontally on the horizontal slide rack 100, with the specimen carrying surface facing upward. This allows easy observation and allows precious reagents to be added and maintained on top of the specimen for incubation. However, horizontal slide racks, such as the slide rack 100, cannot be used to perform submerging and/or washing steps because the positions of the slides on the rack are held by gravity and fiction. They are not “locked” on the rack. As a result, slides can float away and get damaged during washing.

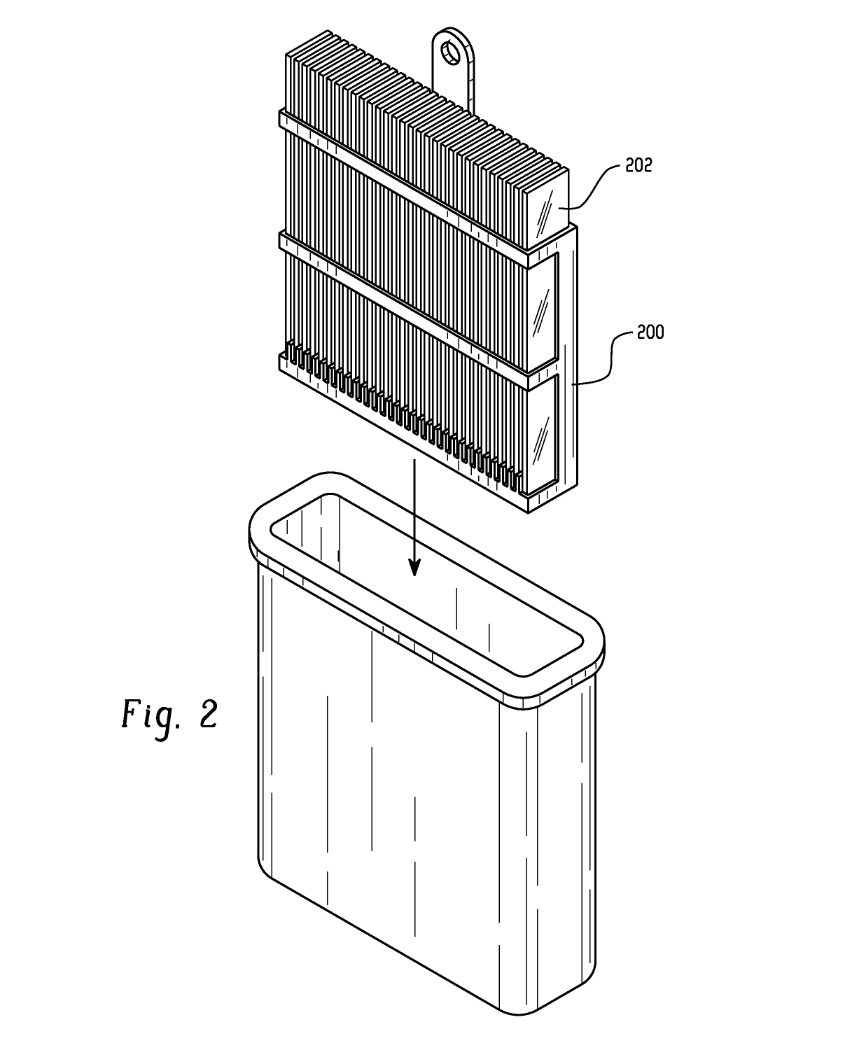

FIG. 2 depicts a vertical slide rack 200. As shown in FIG. 2, microscope slides 202 are held with the specimen carrying surface in a vertical position. This type of rack takes up less space and is normally used to conduct washing or other assay steps that require slides to be submerged or washed in bulk reagents.

Many assays used for scientific research and disease diagnosis comprise a repeated sequence of incubation and washing steps. Slides often have to be individually transferred back and forth between horizontal and vertical racks between these steps, which is a very tedious, time consuming and labor intensive task. In addition, it is beneficial to minimize the manual handling of individual slides because such handling can lead to sample contamination and damage.

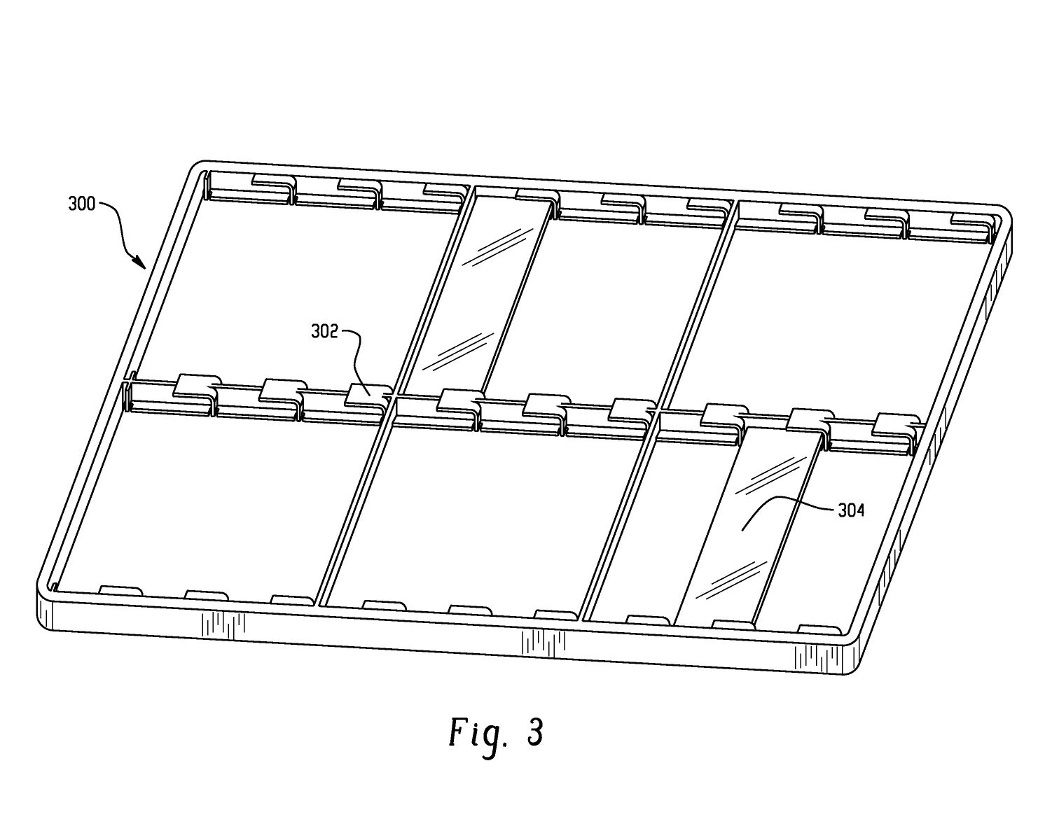

FIG. 3 depicts a slide rack 300 with a fixed cage structure 302. As shown in FIG. 3, a microscope slide loaded on the rack 300 is confined in the fixed cage structure 302 at both ends. The problem with such a design is that the slide 304 can move around inside the constrain case a great deal, which means that a large volume of bulk reagent is needed to completely submerge all slides on the rack 300. In addition, the slides are not securely constrained and locked. Many assays require shaking off excess residual liquids and/or buffers after washing. During such a procedure, the slides can fall out of the rack 300, which may lead to loss of precious specimens and data.

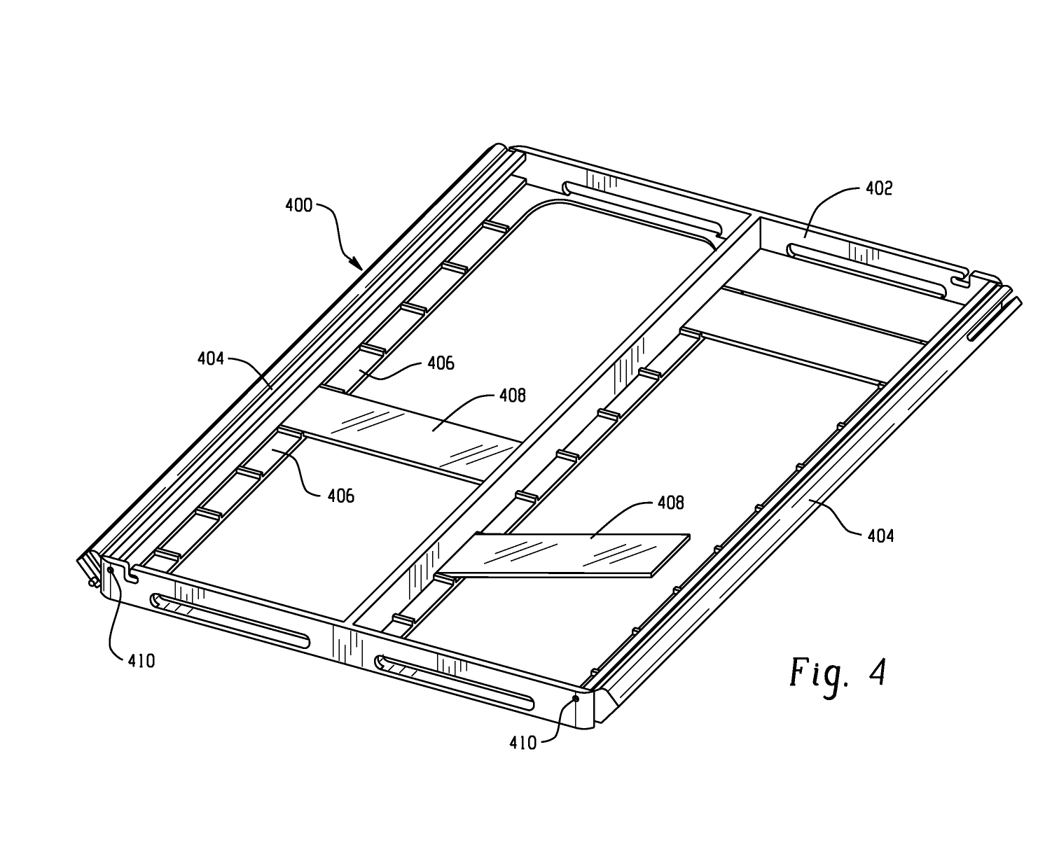

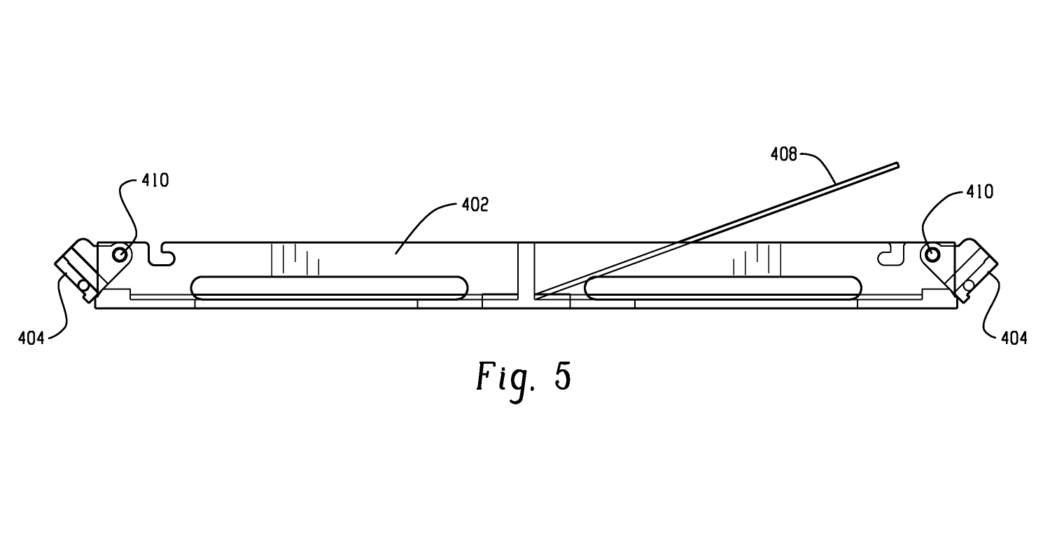

FIG. 4 depicts an example lock-in slide rack assembly 400, according to one embodiment of the present invention. As shown in FIG. 4, the lock-in slide rack assembly 400 comprises a rack body 402 and one or more swing clamps 404. The rack body 402 provides a platform on which one or more microscope slides 408 can be laid horizontally. There are optional fixed structures 406 around the slides 408 that prevent the slides from slipping horizontally. The swing clamps 404 can rotate around an axis 410 positioned at the edge of the clamps 404, and the axis 410 is also installed on one side of the rack body 402. As shown in FIG. 4, the clamps 404 can rotate and “swing” to an “open” position away from the rack body 402, allowing the slides 408 to be easily placed onto the rack body 402. FIG. 5 depicts a side, see-through view of the example rack assembly 400, where the swing clamps 404 rotate to an open position allowing the microscope slides 408 being loaded onto the rack 402.

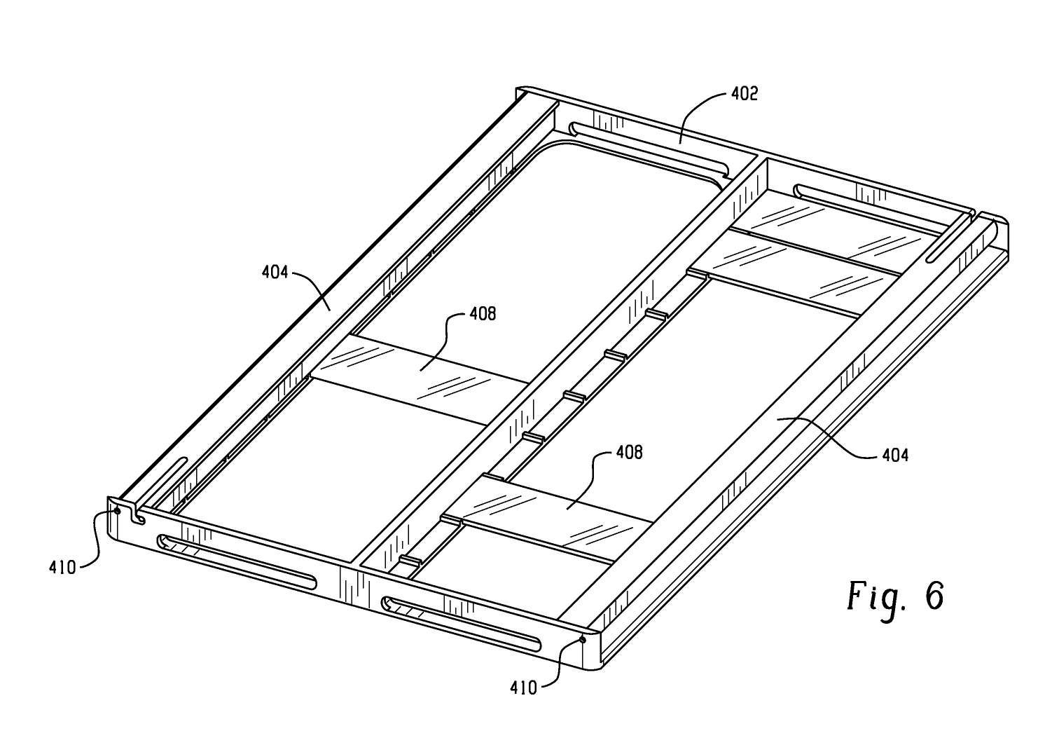

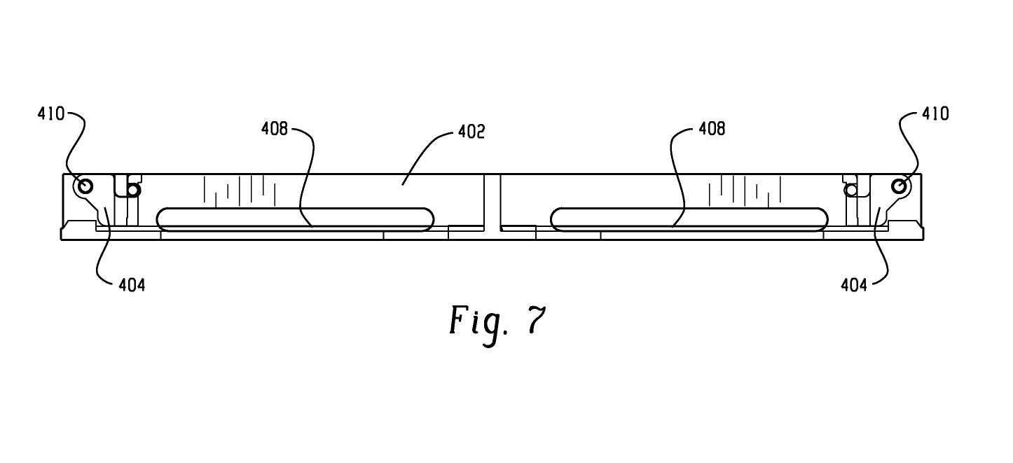

Once all the microscope slides 408 are loaded onto the rack 402, the swing clamps 404 can rotate to a “closed” position to secure the slides on the rack body 402, as shown in FIG. 6. FIG. 7 depicts a side, see-through view of the example rack assembly 400, where the swing clamps 404 rotate to a closed position to secure the slides 408 on the rack 402.

The lock-in slide rack assembly described above is merely an example which should not unduly limit the scope of the claims. One of ordinary skill in the art would recognize many variations, alternatives, and modifications. For example, the slide rack assembly may comprise a large single swing clamp to lock multiple rows of microscope slides. In another example, the slide rack assembly may include multiple swing clamps installed on a rack body with each swing clamp locking a row of microscope slides. In still another embodiment, a rack body of the invention can be configured to hold any number of desired slides, including a single slide, but can also be configured to hold multiple slides, for example, 2 or more, 3 or more, 4 or more, 5 or more, 6 or more, 7 or more, 8 or more, 9 or more, 10 or more, 11 or more, 12 or more, 13 or more, 14 or more, 15 or more, 16 or more, 17 or more, 18 or more, 19 or more, 20 or more, 21 or more, 22 or more, 23 or more, 24 or more, 25 or more, 26 or more, 27 or more, 28 or more, 29 or more, 30 or more, 31 or more, 32 or more, 33 or more, 34 or more, 35 or more, 36 or more, 37 or more, 38 or more, 39 or more, 40 or more, 41 or more, 42 or more, 43 or more, 44 or more, 45 or more, 46 or more, 47 or more, 48 or more, 49 or more, 50 or more, 55 or more, 60 or more, 65 or more, 70 or more, 75 or more, 80 or more, 85 or more, 90 or more, 95 or more, 100 or more, or even larger number of slides per rack body, as desired.

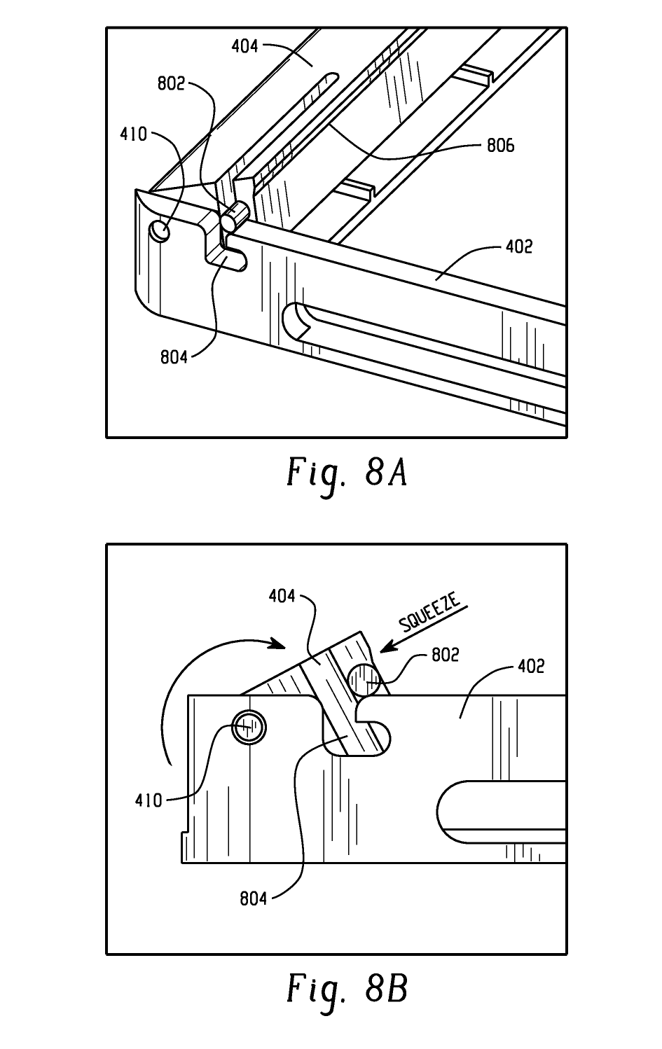

FIGS. 8(a)-8(d) depict an example locking mechanism on the example rack assembly 400, according to one embodiment of the present invention. With the locking mechanism, the clamp 404 can be “locked” at a closed position, so that all slides 408 are securely held at their respective positions on the rack 402 to eliminate the risk of falling or breakage resulting from vigorous washing and shaking As shown in FIG. 8(a), the locking mechanism includes a small extrusion 802 located on the clamp 404 and a slot 804 located on the rack body 402. The inherent material elasticity of the clamp 404 may be implemented to engage the small extrusion 802 on the clamp 404 into the slot 804 on the rack body 402 to lock the clamp 404. For example, a part of the clamp 404 may be removed to form an elastic part 806. Locking and unlocking the clamp 404 can be easily done with one hand by squeezing the elastic part 806 of the clamp 404, while swinging the clamp 404 at the same time. FIG. 8(b) depicts a side view of the example locking mechanism on the example rack assembly 400. FIG. 8(c) depicts the clamp 404 rotating into a “locked” position, where the small extrusion 802 fits into the slot 804. FIG. 8(d) depicts a side view of the clamp 404 rotating into a “locked” position.

The locking mechanism described above is merely an example which should not unduly limit the scope of the claims. One of ordinary skill in the art would recognize many variations, alternatives, and modifications. As an example, the small extrusion 802 may be located on the rack body 402, and the slot 804 may be located on the clamp 404.

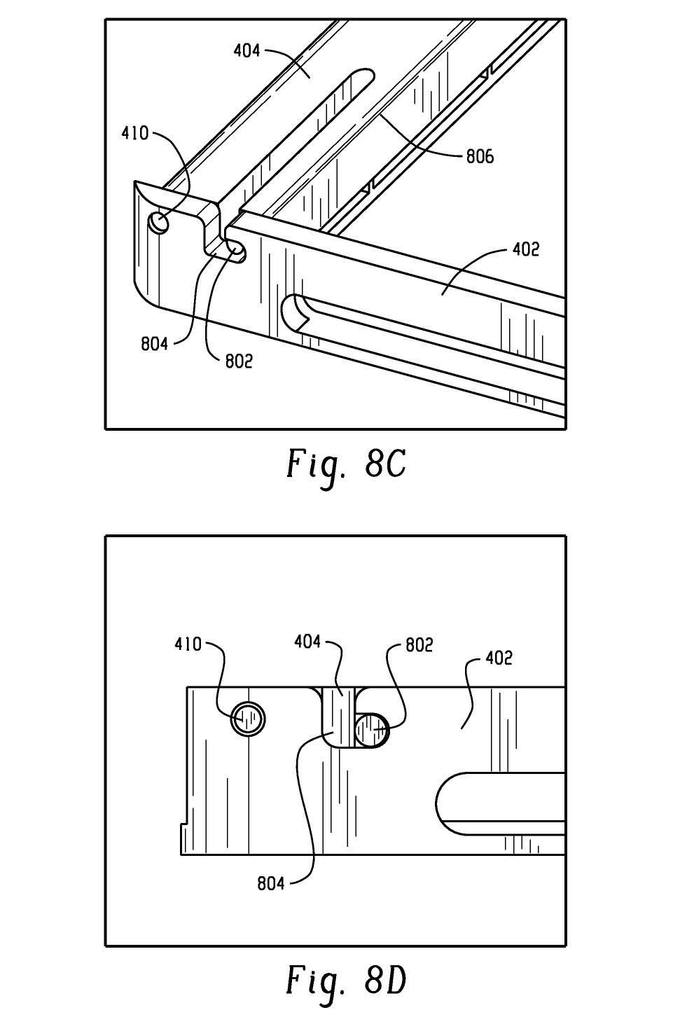

FIG. 9 depicts the example lock-in slide assembly 400, loaded with the slides 408 inside a flat-bottom bulk reagent tray 902. As shown in FIG. 9, when the slides 408 are locked in position on the rack 402, the specimen carrying surfaces of the slides 408 are very close to the bottom of the rack 402. In this way, when the rack 402 is placed in the flat-bottom tray 902, only a small amount of bulk reagent is needed in the tray 902 to completely submerge the slides 408. With the slides 408 on the rack 402 submerged in bulk reagent in the tray 902, washing of the slides 408 can be achieved by sliding the tray 902 back and forth on a flat surface or placing the tray 902 containing bulk reagent on a shake table.

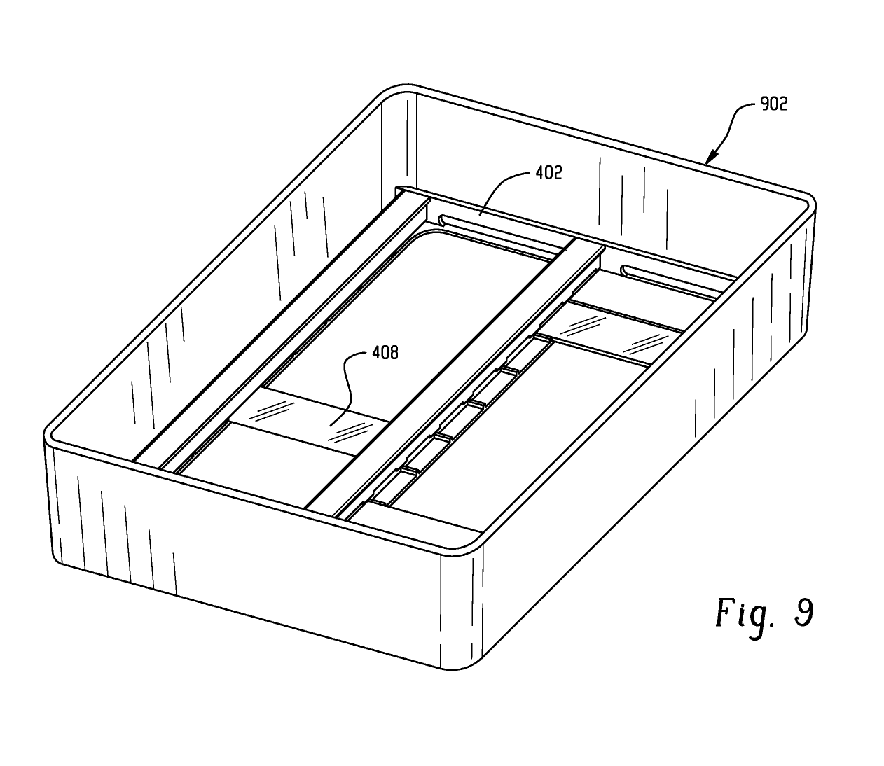

FIG. 10 depicts an example lock-in slide assembly 1000 with swing clamps and an additional fixed clamp, according to another embodiment of the present invention. As shown in FIG. 10, the lock-in slide rack assembly 1000 comprises a rack body 1002, one or more swing clamps 1004, and a fixed clamp 1020. The swing clamps 1004 can rotate around an axis 1010 positioned at the edge of the clamps 1004, and the axis 1010 is also installed on one side of the rack body 1002. For example, the clamp 1020 is fixed on the rack body 1002 and is designed to be relatively shallow in order to provides constraint to microscope slides 1008.

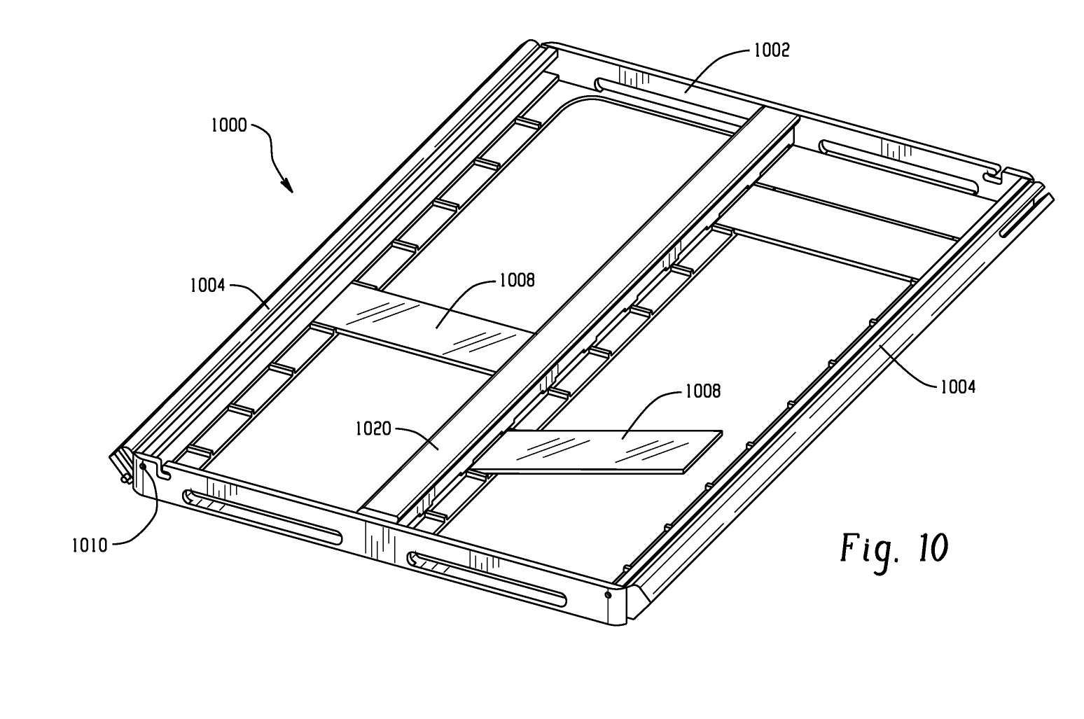

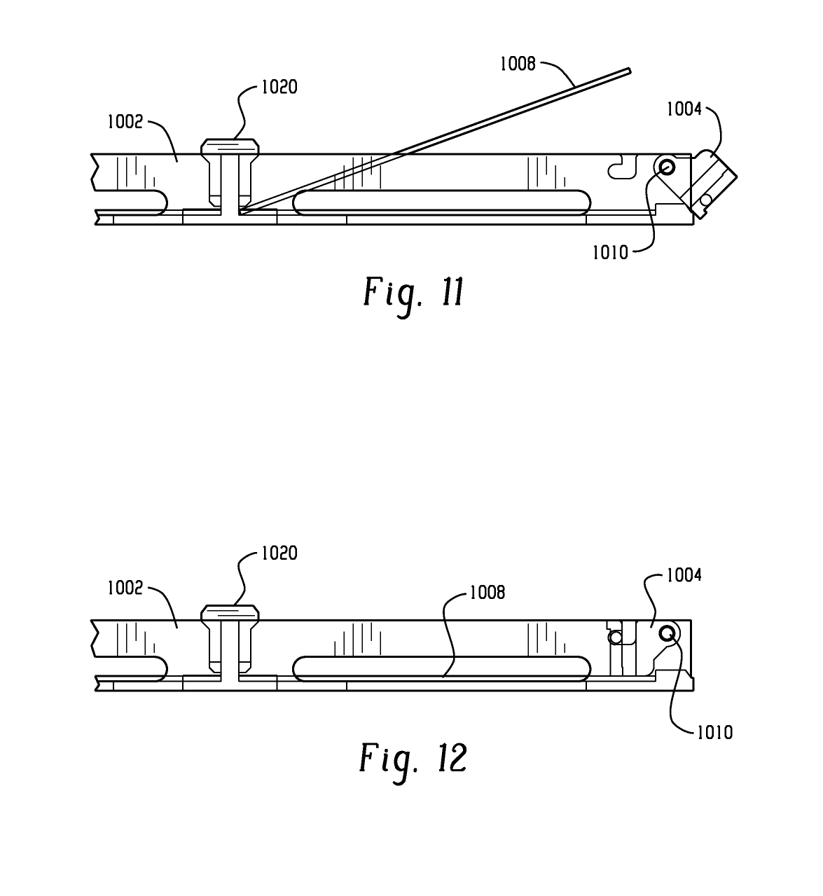

FIG. 11 depicts a side, see-through view of the example lock-in slide assembly 1000 during a slide-loading operation. The swing clamps 1004 can rotate and “swing” to an “open” position away from the rack body 1002 to allow the slides 1008 to be easily placed onto the rack body 1002, and opposite to the clamps 1004, the fixed clamp 1020 constrains the slides 1008. A side, see-through view of the example lock-in slide assembly 1000 as shown in FIG. 12 illustrates that the fixed clamp 1020 helps to securely lock the slides 1008 in position when the swing clamps 1004 rotate to a “closed” position.

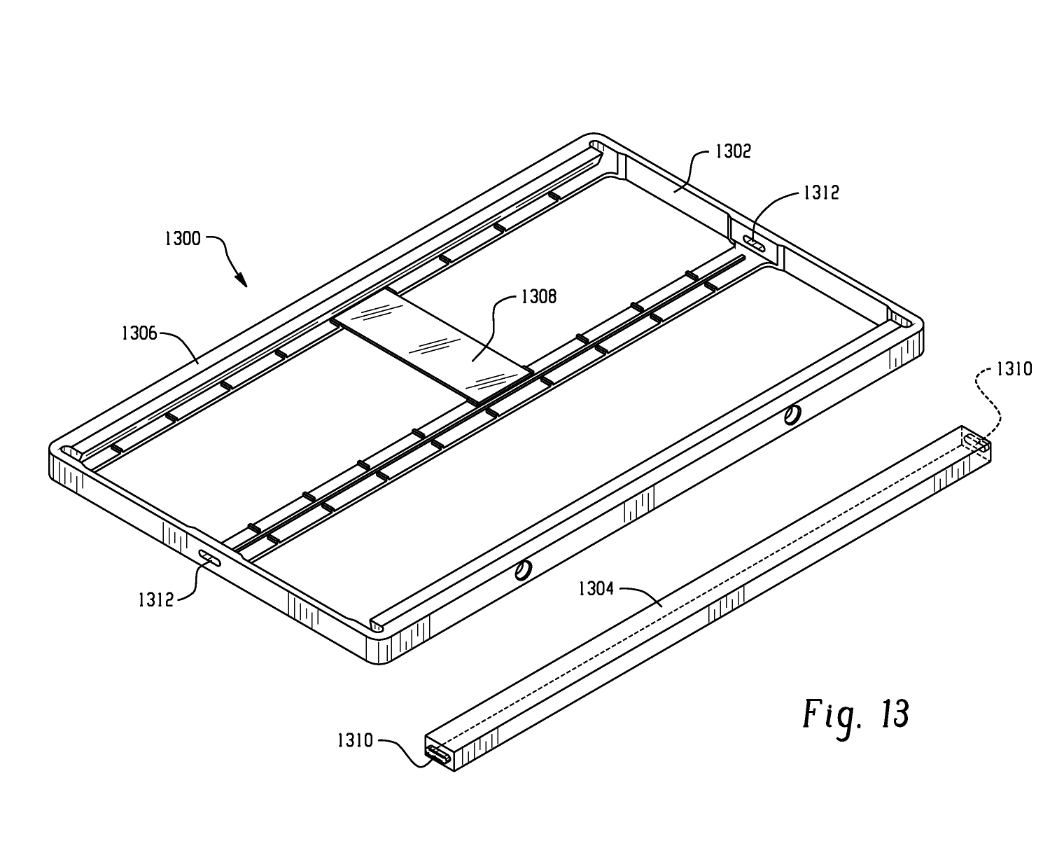

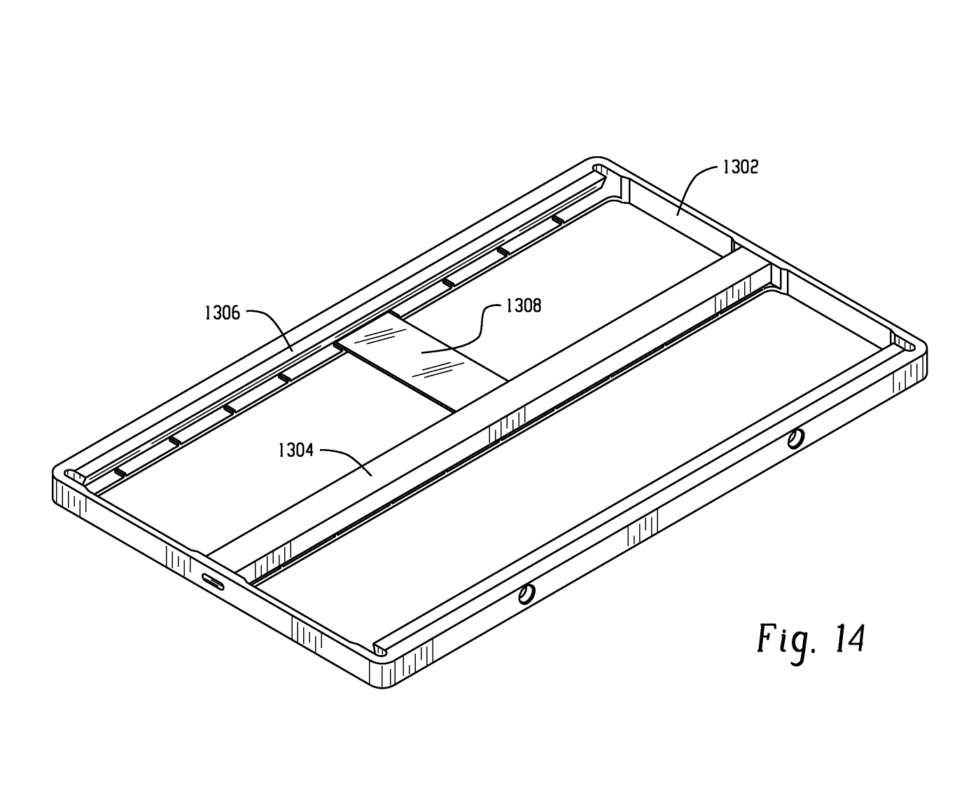

FIG. 13 depicts an example lock-in slide assembly 1300 with a central clamp, according to yet another embodiment of the present invention. The lock-in slide assembly 1300 includes a rack body 1302, a central clamp 1304, and two side clamps 1306. The side clamps 1306 are fixed to the rack body 1302. As shown in FIG. 13, at an “open” position, the central clamp 1302 can be completely removed from the rack 1302, allowing microscope slides 1308 to be easily loaded into the rack 1302. After all the slides 1308 are loaded onto the rack 1302, the central clamp 1304 is installed on the rack 1302 to a “closed” position by inserting small extrusions 1310 located at both ends of the central clamp 1304 into two fitting slots 1312 at both sides of the rack body 1302, as shown in FIG. 14.

For example, the body of the central clamp 1304 is made of elastic material, and thus can be bent a little to temporarily shorten the length of the central clamp 1304, allowing the extrusions 1310 to be inserted into the slots 1312. After installation, the central clamp 1304 reflexes back, matching the length of the rack body 1302. The central clamp is now in the “closed” position, securely holding the slides 1308 in their respective positions on the rack 1302. To open the central clamp 1304 again, the body of the central clamp 1304 is again bent a little along its long axis, allowing the extrusions 1310 to disengage from the corresponding fitting slots 1312 in the rack body 1302. The central clamp 1304 can then be removed from the rack 1302 and is back to the “open” position.

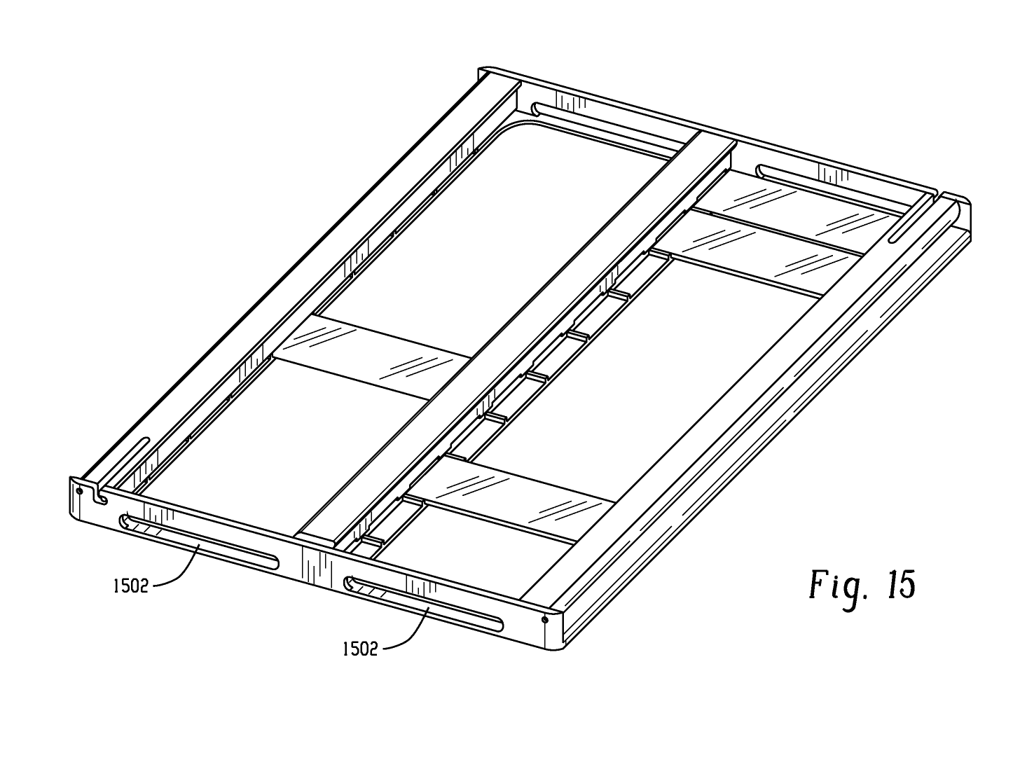

FIG. 15 depicts example openings 1502 in an example lock-in slide assembly for fluid access and drainage. Multiple openings may be instituted on a rack body of an example slide assembly (e.g., the example lock-in slide assembly 400, the example lock-in slide assembly 1000, or the example lock-in slide assembly 1300) to allow bulk reagents to quickly enter and drain away from microscope slides loaded onto the example slide assembly.

The invention provides an apparatus for securing an object on a frame. For example, the object can comprise a surface for displaying a sample. In one embodiment, the apparatus can comprise a first clamping member movably mounted on a frame; wherein the first clamping member changes from an open position to a closed position to secure an object on the frame. In another embodiment the apparatus can further comprise a first locking member located on the first clamping member; and a second locking member located on the frame. If desired, the locking member can be located on the clamping member and/or on the frame.

In yet another embodiment of the invention, an apparatus of the invention can comprise a first clamping member, wherein the first clamping member is rotatably mounted on the frame; and rotation of the first clamping member in a first direction allows the first locking member to engage with the second locking member so that the first clamping member changes from the open position to the closed position. In another embodiment of an apparatus of the invention, rotation of the first clamping member in a second direction allows the first locking member to disengage from the second locking member so that the first clamping member changes from the closed position to the open position.

In still another embodiment of an apparatus of the invention, the first locking member can include or comprise an extrusion, and the second locking member can include or comprise a slot. In a particular embodiment of the invention, engagement of the first locking member with the second locking member allows the extrusion to fit into the slot.

In another embodiment, the first clamping member is mounted close to a first side of the frame. In another embodiment, the apparatus can further comprise a second clamping member rotatably mounted close to a second side of the frame. In another embodiment, the apparatus comprises a third locking member located on the second clamping member; and a fourth locking member located on the frame; wherein rotation of the second clamping member in a second direction allows the third locking member to engage with the fourth locking member. In another embodiment the apparatus comprises a third locking member located on the second clamping member and extending above the frame; and extension of the third locking member above the frame allows at least part of the object to be inserted between the third locking member and the frame. In yet another embodiment of the invention, engagement of the first locking member with the second locking member secures the object close to a bottom of the frame.

In another embodiment, an apparatus of the invention comprises a frame, wherein the frame includes a plurality of elongated base members extending along a second direction in a parallel, spaced-apart relationship; and a plurality of elongated wall members extending along a third direction in a parallel, spaced-apart relationship, the wall members attached to the base members, the third direction being perpendicular to the second direction. In another embodiment, the wall members extend along a fourth direction in a parallel, spaced-apart relationship, the fourth direction being perpendicular to the second direction and the third direction. In another embodiment, the first clamping member is located on an elongated base member, and the second locking member is located on an elongated wall member.

In another embodiment, an apparatus of the invention can further comprise a first locking member located on the first clamping member; and a second locking member located on a frame; wherein mounting the first clamping member movably onto the frame allows the first locking member to engage with the second locking member so that the first clamping member changes from the open position to the closed position. In another embodiment, the first clamping member is movably mounted onto the frame by bending the first clamping member to allow the first locking member to engage with the second locking member.

In another embodiment of an apparatus of the invention, the first clamping member can be bent to allow the first locking member to disengage from the second locking member. In another embodiment, an apparatus of the invention can further comprise a second clamping member fixedly mounted on the frame to constrain the object. In still another embodiment of the invention, the apparatus comprises a frame, wherein the frame has one or more openings for a fluid to flow in contact with the object.

The invention additionally provides a method for securing an object on a frame. The method can comprise moving a clamping member movably mounted on a frame to an open position; placing an object on the frame; and moving the clamping member to a closed position to secure the object on the frame.

The invention also provides an apparatus for securing an object on a frame, wherein the object comprises a surface for displaying a sample. Such an apparatus can comprise a first clamping member rotatably mounted on a frame; a first locking member located on the first clamping member; and a second locking member located on the frame; wherein rotation of the first clamping member in a first direction allows the first locking member to engage with the second locking member to secure an object on the frame.

In an embodiment of an apparatus of the invention, rotation of the first clamping member in a second direction allows the first locking member to disengage from the second locking member. In another embodiment, the first locking member can include or comprise an extrusion. In another embodiment, the second locking member can include or comprise a slot. In another embodiment, engagement of the first locking member with the second locking member allows the extrusion to fit into the slot.

In another embodiment of an apparatus of the invention, the first clamping member can rotate around an axis. In another embodiment, the first clamping member is mounted close to a first side of the frame. In another embodiment, an apparatus of the invention can further comprise a second clamping member rotatably mounted close to a second side of the frame.

In still another embodiment, an apparatus of the invention can comprise a third locking member located on the second clamping member; and a fourth locking member located on the frame; wherein rotation of the second clamping member in a second direction allows the third locking member to engage with the fourth locking member. In another embodiment, an apparatus of the invention can further comprise a second clamping member fixedly mounted on the frame.

In another embodiment, an apparatus of the invention can comprise a third locking member located on the second clamping member and extending above the frame; and extension of the third locking member above the frame allows at least part of the object to be inserted between the third locking member and the frame. In another embodiment of the invention, engagement of the first locking member with the second locking member secures the object close to a bottom of the frame.

In another embodiment of an apparatus of the invention, the apparatus comprises a frame, wherein the frame has one or more openings for a liquid to flow in contact with the object. In another embodiment, the apparatus of the invention comprises a frame, wherein the frame includes a plurality of elongated base members extending along a second direction in a parallel, spaced-apart relationship; and a plurality of elongated wall members extending along a third direction in a parallel, spaced-apart relationship, the wall members attached to the base members, the third direction being perpendicular to the second direction. In an embodiment of the invention, the wall members of the apparatus extend along a fourth direction in a parallel, spaced-apart relationship, the fourth direction being perpendicular to the second direction and the third direction. In another embodiment, the first clamping member is located on an elongated base member, and the second locking member is located on an elongated wall member.

The invention additionally provides an apparatus for securing an object on a frame, wherein the object comprises a surface for displaying a sample. Such an apparatus of the invention can comprise a first clamping member; a first locking member located on the first clamping member; and a second locking member located on a frame; wherein mounting the first clamping member movably onto the frame allows the first locking member to engage with the second locking member to secure an object on the frame.

In another embodiment, an apparatus of the invention can further comprise a second clamping member fixedly mounted on the frame to constrain the object when the object is loaded onto the frame. In another embodiment, the first clamping member is movably mounted onto the frame by bending the first clamping member to allow the first locking member to engage with the second locking member. In another embodiment, the first clamping member is bent to allow the first locking member to disengage from the second locking member.

The invention also provides a method for securing an object on a frame. The method can comprise rotating a clamping member rotatably mounted on a frame in a first direction to disengage a first locking member located on the clamping member from a second locking member located on the frame; placing an object on the frame; and rotating the clamping member in a second direction to engage the first locking member with the second locking member to secure the object on the frame. It is understood that a method of securing an object on a frame can be applied to any apparatus of the invention disclosed herein.

In an embodiment of the invention, the object to be secured to the apparatus of the invention includes or comprises a microscope slide.

Although the invention has been described above, it should be understood that various modifications can be made without departing from the spirit of the invention. The patentable scope of the invention may include other examples that occur to those skilled in the art. In some embodiments, the systems and methods described herein may be implemented to allow different assay steps involving precious or bulk reagents to be carried out using a same lock-in slide rack. In certain embodiments, the systems and methods described herein may be implemented in manual assays and/or in automated assays.

What is claimed is:

1. An apparatus for securing an object on a frame, wherein the object comprises a surface for displaying a sample, the apparatus comprising:
a first clamping member movably mounted on a frame;
wherein the first clamping member changes from an open position to a closed position to secure an object on the frame.

2. The apparatus of claim 1, further comprising:
a first locking member located on the first clamping member; and
a second locking member located on the frame.

3. The apparatus of claim 2, wherein:
the first clamping member is rotatably mounted on the frame; and
rotation of the first clamping member in a first direction allows the first locking member to engage with the second locking member so that the first clamping member changes from the open position to the closed position.

4. The apparatus of claim 3, wherein rotation of the first clamping member in a second direction allows the first locking member to disengage from the second locking member so that the first clamping member changes from the closed position to the open position.

5. The apparatus of claim 3, wherein the first locking member includes an extrusion, and the second locking member includes a slot.

6. The apparatus of claim 5, wherein engagement of the first locking member with the second locking member allows the extrusion to fit into the slot.

7. The apparatus of claim 3, wherein the first clamping member is mounted close to a first side of the frame.

8. The apparatus of claim 7, further comprising a second clamping member rotatably mounted close to a second side of the frame.

9. The apparatus of claim 8, wherein:
a third locking member located on the second clamping member; and
a fourth locking member located on the frame;
wherein rotation of the second clamping member in a second direction allows the third locking member to engage with the fourth locking member.

10. The apparatus of claim 9, wherein:
a third locking member located on the second clamping member and extending above the frame;
extension of the third locking member above the frame allows at least part of the object to be inserted between the third locking member and the frame.

11. The apparatus of claim 3, wherein engagement of the first locking member with the second locking member secures the object close to a bottom of the frame.

12. The apparatus of claim 3, wherein the frame includes:
a plurality of elongated base members extending along a second direction in a parallel, spaced-apart relationship; and
a plurality of elongated wall members extending along a third direction in a parallel, spaced-apart relationship, the wall members attached to the base members, the third direction being perpendicular to the second direction.

13. The apparatus of claim 12, wherein the wall members extend along a fourth direction in a parallel, spaced-apart relationship, the fourth direction being perpendicular to the second direction and the third direction.

14. The apparatus of claim 13, wherein the first clamping member is located on an elongated base member, and the second locking member is located on an elongated wall member.

15. The apparatus of claim 1, further comprising:
a first locking member located on the first clamping member; and
a second locking member located on a frame;
wherein mounting the first clamping member movably onto the frame allows the first locking member to engage with the second locking member so that the first clamping member changes from the open position to the closed position.

16. The apparatus of claim 15, wherein the first clamping member is movably mounted onto the frame by bending the first clamping member to allow the first locking member to engage with the second locking member.

17. The apparatus of claim 15, wherein the first clamping member is bent to allow the first locking member to disengage from the second locking member.

18. The apparatus of claim 1, further comprising a second clamping member fixedly mounted on the frame to constrain the object.

19. The apparatus of claim 1, wherein the frame has one or more openings for a fluid to flow in contact with the object.

20. An apparatus for securing an object on a frame, wherein the object comprises a surface for displaying a sample, the apparatus comprising:
a first clamping member rotatably mounted on a frame;
a first locking member located on the first clamping member; and
a second locking member located on the frame;
wherein rotation of the first clamping member in a first direction allows the first locking member to engage with the second locking member to secure an object on the frame.

21. An apparatus for securing an object on a frame, wherein the object comprises a surface for displaying a sample, the apparatus comprising:
a first clamping member;
a first locking member located on the first clamping member; and
a second locking member located on a frame;
wherein mounting the first clamping member movably onto the frame allows the first locking member to engage with the second locking member to secure an object on the frame.
